(19) United States
(12) Patent Application Publication
(10) Pub. No.: US 2006/0220962 A1
(43) Pub. Date: Oct. 5, 2006

(54) Circularly polorized square patch antenna

(76) Inventors: Loek J. d'Hont, Rotonda- West, FL (US); Bernard Barink, McKinney, TX (US); Dave Schneider, Flower Mound, TX (US)

Correspondence Address: HAYNES AND BOONE, LLP, 901 MAIN STREET, SUITE 3100, DALLAS, TX, 75202, US

(21) Appl. No.: 11/362,951

(22) Filed: Feb. 27, 2006

Related U.S. Application Data
(60) Provisional application No. 60/657,120, filed on Feb. 28, 2005.

(51) Int. Cl. H01Q 1/38

(52) U.S. Cl. 343/700 MS

(57) ABSTRACT

An antenna comprises a square patch element having first and second feed points and lying in a first plane, the first feed point being disposed near a first edge of the square patch element and substantially bisecting the first edge, and the second feed point being disposed near a second edge of the square patch element and substantially bisecting the second edge. The antenna further comprises a feed structure lying in a second plane parallel with the first plane and having a first segment coupled between a signal point and the first feed point, and a second segment coupled between the signal point and the second feed point, where the first and second segments of the feed structure have unequal lengths. The antenna further comprises a ground plane supporting the feed structure and square patch element.

### PRIORITY DATA

This application claims the benefit of U.S. Provisional Application Ser. No. 60/657,120 entitled “RFID DEVICE AND METHOD,” filed Feb. 28, 2005.

### BACKGROUND

RFID or radio frequency identification technology has been used in a variety of commercial applications such as inventory tracking and highway toll tags. In general, a transceiver tag or transponder transmits stored data by backscattering varying amounts of an electromagnetic field generated by an RFID reader. The RFID tag may be a passive device that derives its electrical energy from the received electromagnetic field or may be an active device that incorporates its own power source. The backscattered energy is then read by the RFID reader and the data is extracted therefrom.

Circularly polarized antennas are commonly used in RFID applications. However, traditional circular polarized antennas do not achieve perfect circular polarity or maintain circular polarity across the entire operating bandwidth. Further, conventional circularly polarized antennas require antenna elements of complex shapes or construction that are more difficult to manufacture.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a top view of an embodiment of antenna elements, feed structure and ground plane;

FIG. 2 is a first side elevational view of the antenna elements, feed structure and ground plane of FIG. 1 taken along lines 2-2;

FIG. 3 is a second side elevational view of the antenna elements, feed structure and ground plane of FIG. 1 taken along lines 3-3; and

FIG. 4 is a cross-sectional view of an embodiment of a radome.

### DETAILED DESCRIPTION

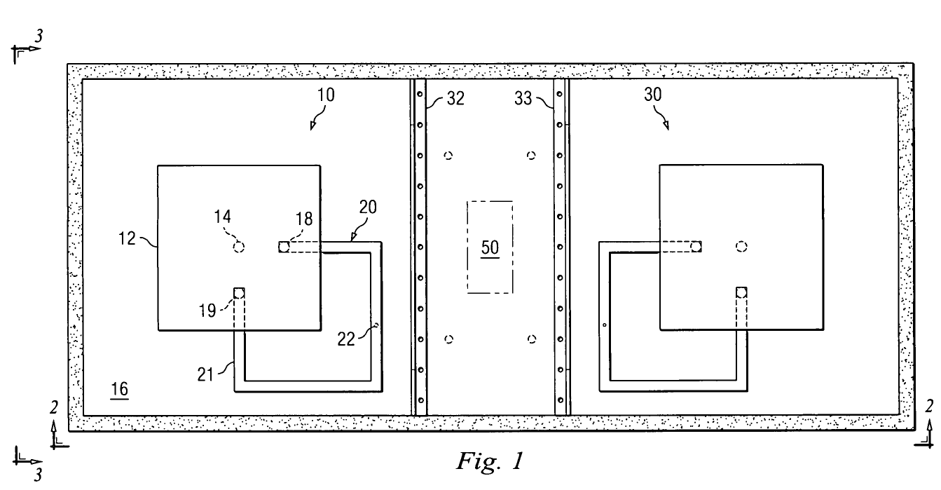

FIG. 1 is a top view of an embodiment of an antenna 10 that may be used for RFID and other suitable applications. Referring also to FIGS. 2 and 3 for side elevational views taken along lines 2-2 and 3-3, antenna 10 comprises a patch element 12 supported by a center support 14 over a ground plane 16. Patch element 12 is constructed of a flat and square piece of a conductive material such as aluminum, copper, steel or another suitable metal. Center support 14 may be constructed of a conductive material such as steel or an insulative material such as plastic. A conductive center support forms a short for DC signals, which may be sensed by a RFID reader. Two feed points 18 and 19 on the patch element are oriented perpendicularly with one another and are each coupled to segments 20 and 21 of a transmission feed structure, respectively. Transmission feed segment 20, coupled to feed point 18, substantially bisects one side of the square patch element and comprises one ninety degree angle prior to connecting to coaxial connector 22. Transmission feed segment 21, coupled to feed point 19, substantially bisects an adjacent side of the square patch element and comprises two ninety degree angles prior to connecting to coaxial connector 22. Transmission feed segments 20 and 21 form a signal feed structure that resides on a plane non-co-planar or offset from the patch element. In particular, the feed structure resides in a plane parallel with but below that of patch element 12. The transmission feed segments may be formed from a conductive strip constructed of heavy gauge metal such as brass, copper or another suitable material so that they also provide structural support and mechanical reinforcement for the antenna patch element.

The location of the feed points, the impedance of the transmission feed segments, and the impedance of the signal feed connector coupled to the transmission feed segments are chosen so that impedances are matched thus not requiring impedance transformation. The distance of the feed points from the center of the patch element is chosen so that the feed points are each at an impedance of 100 ohms on the patch element. Each transmission feed segment has an impedance of 100 ohms and both are coupled together to a 50 ohm coaxial connector 22 coupled to a 50 ohm coaxial cable 24. In one exemplary embodiment, square patch element 12 is 5.394 inches on each side, transmission feed segments 20 and 21 are 6.081 inches and 10.425 inches, respectively, and feed points 18 and 19 are located 1.180 inches from the edge of the patch element. Other suitable dimensions may be used. A resistance element such as a resistor 26 may be coupled between patch element 12 and ground plane 16.

In operation, the unequal lengths of transmission feed segments 20 and 21 causes different signal phases to arrive at the antenna patch element from the two feed points to achieve circular polarization. The difference in length between the two transmission feed segments may be tweaked by varying the point at which coaxial connector 22 is coupled to the feed structure to achieve perfect circular polarization. Therefore, the antenna may be tweaked or adjusted in this manner in the field at installation time. The coaxial connector may be located anywhere along the transmission feed structure because the 50 ohms resistance exists at any point along the transmission line. The difference in length that creates a ninety degree phase difference between the two feed points determines how close to perfect circular polarization the antenna may get.

Because the signal feed structure resides in a plane below that of patch element 12, antenna 10 avoids the problem of distorted radiation pattern. Such is the problem of a dual-feed antenna with its feed structure residing in the same plane as the patch element.

The value R of resistor 26 may be chosen to be sufficiently large so as to not impact RF impedance. Using an insulative center support, different antennas with different resistor values may be identified by the RFID reader circuit by sensing the DC resistance across the coaxial cable. The reader may then adjust its power automatically depending on which antenna is connected thereto. Resistor 26 also forms a current path to ground to discharge accumulated electrostatic charge on the patch element. Resistor 26 may be 5 K ohm, 10 K ohm, or another suitable value for example.

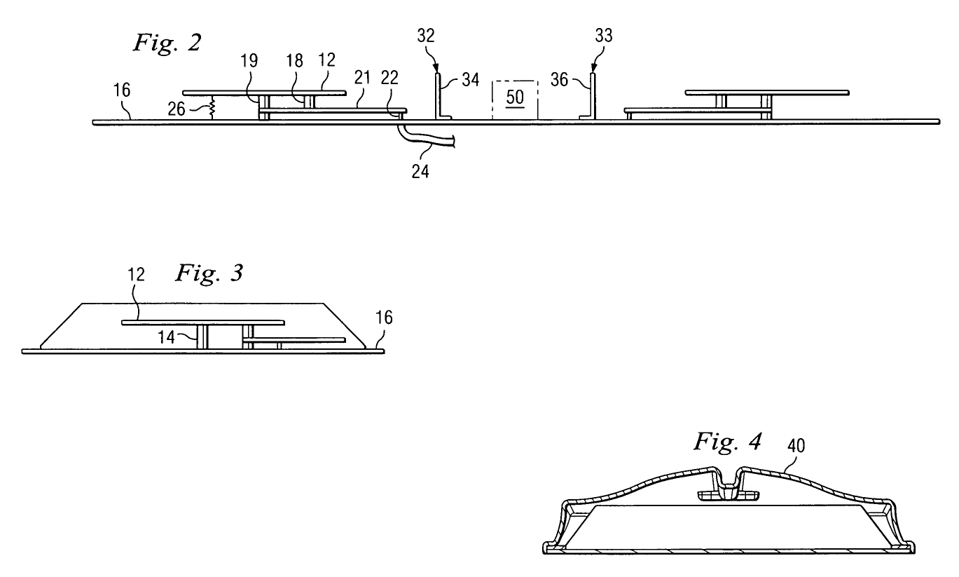

FIG. 1 also shows a second antenna 30 also disposed above the ground plane. Antennas 10 and 30 form a dual-path antenna operable to receive as well as transmit RF signals. Antenna 30 is electromagnetically isolated from antenna 10 by isolator strips 32 and 33. Isolator strips 32 and 33 have L-shaped cross-sections with trapezoidal vertical members 34 and 36 that are shaped to conform with the profiles of a radome 40 (shown in FIG. 4 and described below). The isolator strips are securely fastened to ground plane 16 between antennas 10 and 30. Isolator strips 32 and 33 may be constructed of a conductive material such as aluminum, copper, steel or another suitable material.

Radome 40, as shown in cross-section in FIG. 4, is a top lid or cover that hermetically seals antennas 10 and 30 from the environment. The radome also provides added structural integrity and strength to the antenna assembly. The radome may be constructed of a single piece of molded plastic or another suitable material. An RFID reader circuit 50 coupled to antenna 10 may be located between isolator strips 32 and 33. The isolator strips, the radome and the ground plane thus provide an enclosure for the reader circuit. Ground plane 16 not only serves as part of the enclosure for the antennas but also as a heat sink for reader circuit 50.

Although embodiments of the present disclosure have been described in detail, those skilled in the art should understand that various changes, substitutions and alterations may be made without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. An antenna assembly comprising:
a first antenna comprising:
a first patch element disposed in a first plane;
a first feed structure disposed in a second plane parallel with but offset from the first plane and having a first segment coupled between a signal point and a first feed point on the first patch element, and a second segment coupled between the signal point and a second feed point on the patch element, the first and second segments of the first feed structure having unequal lengths; and
a ground plane supporting the first antenna.

2. The antenna assembly of claim 1, wherein the first patch element is square.

3. The antenna assembly of claim 1, wherein the first feed point is disposed near a first edge of the first patch element and substantially bisecting the first edge, and the second feed point is disposed near a second edge of the first patch element and substantially bisecting the second edge.

4. The antenna assembly of claim 1, wherein the first segment of the first feed structure comprises one ninety degree bend.

5. The antenna assembly of claim 1, wherein the second segment of the first feed structure comprises two ninety degree bends.

6. The antenna assembly of claim 1, wherein the first and second feed points are located equidistantly from a center of the first patch element.

7. The antenna assembly of claim 1, wherein the first and second feed points on the first patch element each have an impedance of 100 ohms.

8. The antenna assembly of claim 1 comprising a radome covering and sealing the first antenna over the ground plane.

9. The antenna assembly of claim 1, wherein the first and second segments of the feed structure each has an impedance of 100 ohms.

10. The antenna assembly of claim 1, wherein the signal point comprises a coaxial connector coupling the feed structure segments to a coaxial cable.

11. The antenna assembly of claim 10, wherein the coaxial connector has an impedance of 50 ohms.

12. The antenna assembly of claim 1, further comprising a resistor electrically coupled between the patch element and the ground plane.

13. The antenna assembly of claim 1, further comprising a center support supporting the first square patch element at a center point thereof.

14. The antenna assembly of claim 12, wherein the center support comprises a conductive material.

15. The antenna assembly of claim 12, wherein the center support comprises an insulative material.

16. The antenna assembly of claim 1 further comprising:
a second antenna being a mirror image of the first antenna, the second antenna comprising:
a second square patch element having first and second feed points and disposed in the first plane, the first feed point being disposed near a first edge of the square patch element and substantially bisecting the first edge, and the second feed point being disposed near a second edge of the square patch element and substantially bisecting the second edge;
a second feed structure disposed in the second plane parallel with but offset from the first plane and having a first segment coupled between a signal point and the first feed point on the second square patch element, and a second segment coupled between the signal point and the second feed point, the first and second segments of the feed structure having unequal lengths; and
the ground plane supporting the second antenna.

17. The antenna assembly of claim 16, further comprising at least one isolating strip disposed between the first and second antennas.

18. The antenna assembly of claim 16, further comprising:
first and second isolating strips disposed between the first and second antennas operable to electromagnetically isolating the first and second antennas; and
an RF reader circuit coupled to the first antenna and disposed between the first and second isolating strips.

19. The antenna assembly of claim 18 comprising a radome covering and sealing the first and second square patch elements and RF reader circuit over the ground plane.

20. The antenna assembly of claim 1, wherein the second feed structure residing in the second plane is disposed between the first plane and the ground plane.

21. A circularly polarized antenna comprising:
a first antenna element comprising:
a first square patch element having first and second feed points and lying in a first plane, the first feed point being disposed near a first edge of the square patch element and substantially bisecting the first edge, and the second feed point being disposed near a second edge of the square patch element and substantially bisecting the second edge;
a first feed structure lying in a second plane below the first plane and having a first segment coupled between a signal point and the first feed point, and a second segment coupled between the signal point and the second feed point, the first and second segments of the first feed structure having unequal lengths; and
a second antenna element comprising:
a second square patch element having first and second feed points and lying in the first plane, the first feed point being disposed near a first edge of the square patch element and substantially bisecting the first edge, and the second feed point being disposed near a second edge of the square patch element and substantially bisecting the second edge;
a second feed structure lying in the second plane below the first plane and having a first segment coupled between a signal point and the first feed point, and a second segment coupled between the signal point and the second feed point, the feed structure having three 90 degree bends and the first and second segments of the feed structure having unequal lengths; and
a ground plane supporting the first and second antenna elements.

22. The antenna of claim 21 comprising a radome coupled to the ground plane and forming an hermetically sealed enclosure therein.

23. The antenna of claim 21, further comprising two isolating strips disposed between the first and second antenna elements.

24. The antenna of claim 23, further comprising an RFID reader circuit coupled to the first antenna element and disposed on the ground plane between the two isolating strips.

25. An antenna assembly comprising:
a first square patch element having first and second perpendicular feed points and lying in a first plane, the first feed point being disposed near a first edge of the square patch element and substantially bisecting the first edge, and the second feed point being disposed near a second edge of the square patch element and substantially bisecting the second edge;
a first feed structure lying in a second plane below the first plane and having a first segment coupled between a signal point and the first feed point, and a second segment coupled between the signal point and the second feed point, the first segment having one 90 degree bend and the second segment having two 90 degree bends;
a ground plane onto which the feed structure and the square patch element are securely fastened; and
a radome covering and sealing over the ground plane and enclosing the first square patch element and feed structure.

26. The antenna assembly of claim 25, further comprising a second square patch element and second feed structure configured in a mirror image of the first square patch and first feed structure, and the radome covering and enclosing the second square patch element and second feed structure.

27. An antenna comprising:
a ground plane
a square patch element supported by a rigid center support securely fastened to the ground plane and disposed in a first horizontal plane;
a feed structure coupled to a first and second feed points on the square patch element and disposed in a second horizontal plane below the first plane and having four substantially straight sections coupled sequentially with ninety degree bends, the first section coupled to the first feed point being substantially perpendicular to a first side of the square patch element and the fourth section coupled to the second feed point being substantially perpendicular to an adjacent side of the square patch element, a second section of the feed structure being coupled to a signal feed point; and
a radome covering and enclosing the square patch and feed structure over the ground plane.

28. The antenna of claim 27, wherein the first and second sections of the feed structure are of equal length, and the third and fourth sections of the feed structure are of equal length.

29. The antenna of claim 27, wherein the first and second feed points are located equidistantly from a center of the square patch element.

30. The antenna of claim 27, further comprising a resistor electrically coupled between the square patch element and the ground plane operable to discharge static electrical charges on the square patch element.

31. The antenna of claim 27, further comprising a DC sensing resistor electrically coupled between the square patch element and the ground plane.

32. The antenna of claim 27, wherein the signal feed point may be located anywhere on the feed structure to achieve perfect circular radiation polarization.
